(19) United States
(12) Patent Application Publication
(10) Pub. No.: US 2015/0247481 A1
(43) Pub. Date: Sep. 3, 2015

(54) PORTABLE DEVICE

(71) Applicants: Yosuke Tomita, Aichi (JP); Takahiro Inaguma, Aichi (JP)

(72) Inventors: Yosuke Tomita, Aichi (JP); Takahiro Inaguma, Aichi (JP)

(73) Assignee: OMRON AUTOMOTIVE ELECTRONICS CO., LTD., Aichi (JP)

(21) Appl. No.: 14/632,542

(22) Filed: Feb. 26, 2015

(30) Foreign Application Priority Data
Feb. 28, 2014 (JP) 2014-039010

(51) Int. Cl. F02N 11/08

(52) U.S. Cl. CPC F02N 11/0807

(57) ABSTRACT

A portable device includes a transmission unit which transmits an engine starting signal for starting an engine of a vehicle and an engine stopping signal for stopping the engine of the vehicle to the vehicle. The transmission unit transmits the engine stopping signal with an intensity higher than that of the engine starting signal.

### CROSS-REFERENCES TO RELATED APPLICATIONS

This application is based upon and claims the benefit of priority from Japanese Patent Application No. 2014-039010, filed on Feb. 28, 2014; the entire contents of which are incorporated herein by reference.

### FIELD

One or more embodiments of the present invention relate to a portable device that performs radio communication with a vehicle.

### BACKGROUND

In the related art, various countermeasures have been taken for noise in radio communication between a vehicle and a portable device (FOB) for operating the vehicle. For example, Japanese Unexamined Patent Application Publication No. 2004-197649 discloses an engine control system that can guarantee communication with high reliability in which deterioration due to noise is prevented. In the engine control system, interactive communication is performed between a portable device on a user side and a transceiver on a vehicle side, a motor having a high-voltage battery as a power source is provided, and the operation of a switching noise source connected to the battery is limited when communication is performed between the portable device and the transceiver.

Japanese Unexamined Patent Application Publication No. 2007-191891 discloses a remote control system for an onboard device that can improve reliability of radio communication with a portable device without deteriorating convenience. The remote control system for an onboard device includes an onboard device and a portable device, and the portable device includes a received magnetic field intensity detecting unit that detects a reception state from the onboard device and returns RSSI information which is information indicating the reception state detected by the received magnetic field intensity detecting unit when receiving a call signal transmitted from the onboard device. The onboard device displays the received RSSI information with an alarm unit and allows a user to check that the system can normally operate even at the time of operation of the onboard device in which electromagnetic noise of the vehicle interfering with the radio communication with the portable device increases.

Japanese Unexamined Patent Application Publication No. 2003-191824 discloses a remote control system for an onboard device that can guarantee a stable communication area before starting a vehicle power source and suppress occurrence of a communication error due to driving thereof after starting the vehicle power source in regard to communication between the onboard device and a portable device. The remote control system for an onboard device is provided with an onboard device that can transmit request signals having different frequencies and a portable device that can receive the request signals having different frequencies, which have been transmitted from the onboard device. When engine starting control is performed before starting an engine, downlink communication from the onboard device to the portable device is performed using radio waves of a low frequency of 134 kHz. On the other hand, when a process of checking whether the portable device is present in the vehicle interior is performed after starting the engine, the downlink communication from the onboard device to the portable device is performed using radio waves of a high frequency of 300 MHz.

Japanese Unexamined Patent Application Publication No. 2006-103355 discloses a smart keyless control system that can avoid an influence of electromagnetic noise from onboard electrical devices and rapidly restart an engine. The smart keyless control system determines whether an engine starting operation is performed within a predetermined amount of time from the previous engine stop when the engine starting operation satisfies a predetermined condition. The engine start is permitted through in-vehicle authentication when the engine starting operation is performed within the predetermined amount of time from the previous engine stop, and the engine start is permitted without the authentication when the engine starting operation is performed after the predetermined amount of time elapses from the previous engine stop. When the engine start is permitted without the authentication, a response request signal is transmitted with a high transmission intensity for the authentication after the predetermined amount of time elapses.

Japanese Unexamined Patent Application Publication No. 2010-223052 discloses an onboard device that can satisfactorily transmit a control result of a vehicle to a portable device with low power consumption. The onboard device detects an intensity of a signal when the signal is received from the portable device, and returns a signal indicating a vehicle control process of controlling the vehicle and a control result thereof to the portable device with an intensity corresponding to the detected intensity of the signal in response to the received signal.

Japanese Unexamined Patent Application Publication No. 2006-089946 discloses a portable device that can easily and satisfactorily control a communication-enabled area with a controller. The portable device performs interactive radio communication with an onboard device for controlling a door lock driving device or an engine starting device of a vehicle and remotely controls the onboard device on the basis of the communication. The portable device receives a request signal transmitted from the onboard device and decreases or increases the reception sensitivity thereof by a predetermined sensitivity level to adjust the reception sensitivity.

Japanese Unexamined Patent Application Publication No. 2010-265611 discloses a remote control system that can simply set a communication area corresponding to a remote control target. The remote control system wirelessly transmits information on the response sensitivity of a portable device suitable for a vehicle (vehicle type or the like) when a registration request signal for requesting for performing a portable device registering process is input from the outside. When information on the response sensitivity wirelessly transmitted from the vehicle side is received, the portable device sets its response sensitivity on the basis of the information and wirelessly transmits its specific identification information to the vehicle side.

### SUMMARY

When radio communication is performed between a vehicle and a portable device, noise is generated due to operation of an engine or the like, and thus a communication-enabled distance varies in a state in which the engine of the vehicle or the like is in operation and in a state in which the engine is stopped. For example, in a system (for example, a system having a remote engine starting function) for remotely starting an engine or the like, noise when the engine is turned off to switch the engine from the operation state to the stopped state is stronger than that when the engine is turned on to switch the engine from the stopped state to the operation state by the remote operation from the portable device. Then, when signals of the same transmission intensity are used in the engine turning-on operation and the engine turning-off operation and the operations are performed at the same position by a user, a situation in which the turning-on operation is possible but the turning-off operation is not possible occurs. Particularly, when the operations are performed by the user at a remote position at which the user cannot see the vehicle with eyes or engine sound of the vehicle is not heard, this situation occurs. Since the user thinks that the turning-off operation can be performed at a position at which the turning-on operation can be performed, the operation state of the engine is maintained in spite of the user's operation of turning off the engine and the user cannot recognize this situation.

One or more embodiments of the invention provide a portable device that can guarantee reliability of communication without depending on a vehicle state and that can suppress power consumption of the portable device in radio communication with a vehicle, which is performed by the portable device.

According to one or more embodiments of the invention, there is provided a portable device including a transmission unit which transmits an engine starting signal for starting an engine of a vehicle and an engine stopping signal for stopping the engine of the vehicle to the vehicle, wherein the transmission unit transmits the engine stopping signal with an intensity higher than that of the engine starting signal.

According to this configuration, it is possible to guarantee reliability of communication regardless of a vehicle state generating noise and to prevent the operation state of the engine from being maintained, for example, even when a user turns off the engine. Since it is not always necessary to transmit a signal with a high intensity, it is possible to suppress power consumption of the portable device.

The portable device may further include: a control unit which controls communication using the transmission unit; and a storage unit which stores transmission intensities of the engine starting signal and the engine stopping signal, and the control unit may control the transmission unit so as to transmit the engine starting signal and the engine stopping signal with the respective transmission intensities stored in the storage unit.

According to this configuration, it is possible to transmit signals with the transmission intensities which are appropriately set in advance.

The portable device may further include at least one switch, and the control unit may control the transmission unit so as to transmit the engine starting signal and the engine stopping signal in response to detection of an operation of the at least one switch.

According to this configuration, it is possible to transmit signals depending on a user's intention.

The at least one switch may include an engine start switch for transmitting the engine starting signal and an engine stop switch for transmitting the engine stopping signal.

According to this configuration, a user can easily perform the engine starting operation and the engine stopping operation.

The transmission intensities of the transmission unit may have two levels.

According to this configuration, it is possible to transmit signals with the transmission intensities corresponding to two types of signals.

According to one or more embodiments of the invention, there is provided a portable device including a transmission unit which transmits a starting signal for starting a vehicle and a stopping signal for stopping the vehicle to the vehicle, wherein the transmission unit transmits the stopping signal with an intensity higher than that of the starting signal.

According to this configuration, it is possible to guarantee reliability of communication regardless of a state of an electric automobile generating noise and to prevent the power-on state of the electric automobile from being maintained, for example, even when a user performs a power-off operation of an electric automobile or the like. Since it is not always necessary to transmit a signal with a high intensity, it is possible to suppress power consumption of the portable device.

As described above, according to one or more embodiments of the invention, it is possible to provide a portable device that can guarantee reliability of communication without depending on a state of a vehicle generating noise and that can suppress power consumption of the portable device in radio communication with a vehicle, which is performed by the portable device.

### BRIEF DESCRIPTION OF THE DRAWINGS

FIGS. 1A and 1B are diagrams illustrating communication between a portable device according to an embodiment of the invention and a vehicle, where FIG. 1A illustrates a case in which an engine starting signal is transmitted and FIG. 1B illustrates a case in which an engine stopping signal is transmitted;

FIGS. 2A and 2B are diagrams illustrating a transmission signal level of the portable device according to the embodiment of the invention, where FIG. 2A illustrates a case in which an engine or the like is not in operation and there is no noise and FIG. 2B illustrates a case in which the engine or the like is in operation and there is noise;

FIG. 3 is a block diagram illustrating the portable device according to the embodiment of the invention;

FIGS. 4A and 4B are flowcharts illustrating control steps of the portable device according to the embodiment of the invention, where FIG. 4A illustrates a case in which the engine starting signal is transmitted and FIG. 4B illustrates a case in which the engine stopping signal is transmitted;

FIG. 5 is a flowchart illustrating control steps of operating plural switches of the portable device according to the embodiment of the invention; and

FIG. 6 is a diagram illustrating transmission output intensities by frequencies of the portable device according to the embodiment of the invention.

### DETAILED DESCRIPTION

Hereinafter, an embodiment of the invention will be described with reference to the accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

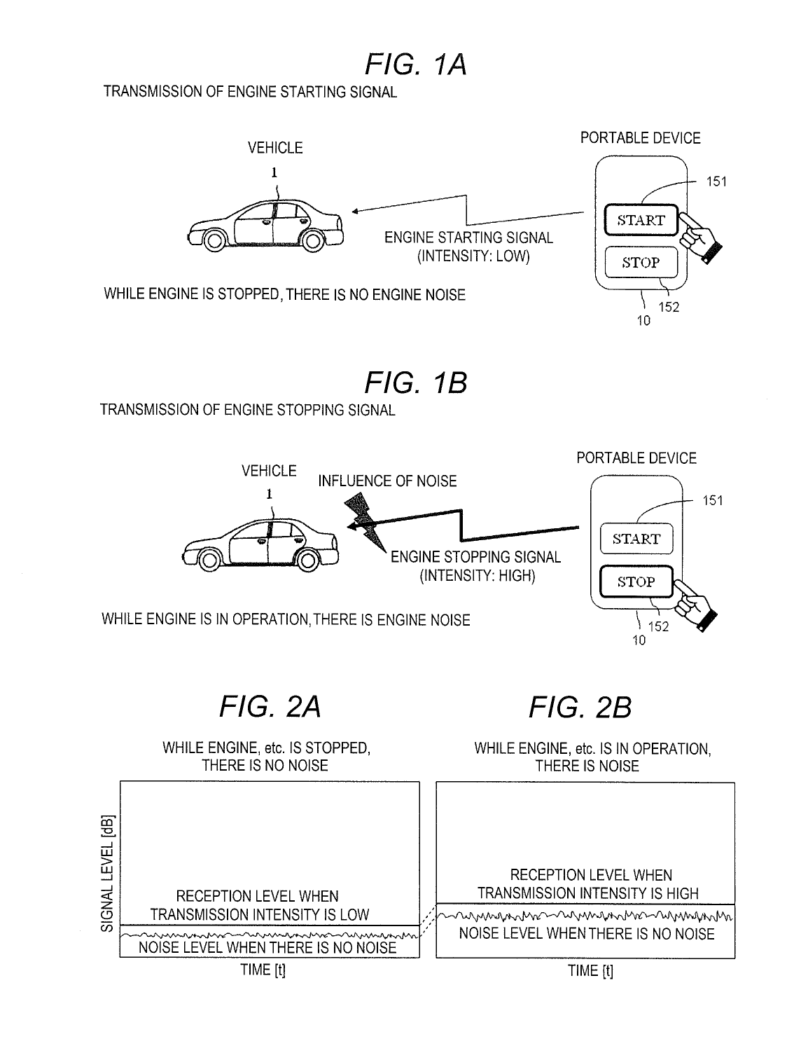

Communication between a portable device 10 according to this embodiment and a vehicle 1 will be described below with reference to FIGS. 1A and 1B and FIGS. 2A and 2B. When radio communication is performed between the vehicle 1 and the portable device 10, electromagnetic waves of various frequencies generated from an engine in operation in the vehicle 1 may serve as noise for electromagnetic waves of the radio communication and may adversely affect the radio communication. Then, in a state in which the engine of the vehicle 1 is in operation and a state in which the engine is stopped, a communication-enabled distance or communication quality of the radio communication may greatly vary. The communication-enabled distance or the communication quality may vary depending on whether an air conditioner, a car navigation device, and the like of the vehicle 1 are in operation as well as the engine. Accordingly, in the embodiment of the invention, the transmission intensity with which a radio signal is transmitted in an environment in which noise based on a vehicle state is present is set to be higher than the transmission intensity in an environment in which the noise is not present.

For example, it is assumed that the vehicle 1 is provided with a remote engine start system. When the engine of the vehicle 1 is turned on by the remote operation from the portable device 10 to switch the engine from the stopped state to the operation state, the engine of the vehicle 1 is not in operation yet and thus no noise is generated from the vehicle 1. On the other hand, when the engine of the vehicle 1 is turned off by the remote operation from the portable device 10 to switch the engine from the operation state to the stopped state, the engine, an air conditioner, or the like is in operation and thus much noise is generated from the vehicle 1.

When a user operates an engine start switch (START button) 151 of the portable device 10 to transmit an engine starting signal so as to start the engine of the vehicle 1, the portable device 10 transits the engine starting signal in an environment in which there is no noise and thus transmits the engine starting signal with a relatively-low transmission intensity. On the other hand, when the user operates an engine stop switch (STOP button) 152 of the portable device 10 to transmit an engine stopping signal so as to stop the engine of the vehicle 1, the portable device 10 transmits the engine stopping signal in an environment in which there is noise and thus transmits the engine stopping signal with a relatively-high transmission intensity. As a result, the signals transmitted from the portable device 10 can be received by the vehicle side even under the influence of noise generated from the vehicle 1 and it is thus possible to guarantee reliability of radio communication without depending on the state of the vehicle 1.

For the purpose of simplification, it has been described above that there is no noise when the engine is stopped, but slight noise (floor noise) is present in an actual environment even when the engine is stopped as illustrated in FIG. 2A. In order to allow the vehicle side to satisfactorily receive a signal from the portable device 10, the SN ratio is preferably made great enough, but the power consumption of the portable device 10 also increases. Accordingly, when the noise level is low, that is, when the engine is stopped, the portable device 10 sets the transmission intensity to a minimum SN ratio necessary for reception and transmits a signal.

As illustrated in FIG. 2B, when the engine or the like is in operation and thus noise increases or is strengthened, the transmission intensity when noise is small is lower than the noise level when there is noise, and thus is buried in the noise. Accordingly, the portable device sets the transmission intensity to a minimum SN ratio necessary for reception and transmits a signal even when noise is generated from the vehicle. As a result, for example, even when the user operates the portable device at a remote position at which the user cannot see the vehicle with eyes or engine sound of the vehicle is not heard, the engine turning-off operation can be performed at the position at which the engine turning-on operation could be performed, and it is thus possible to guarantee the reliability of communication without depending on the state of the vehicle 1 and to suppress the power consumption of the portable device 10.

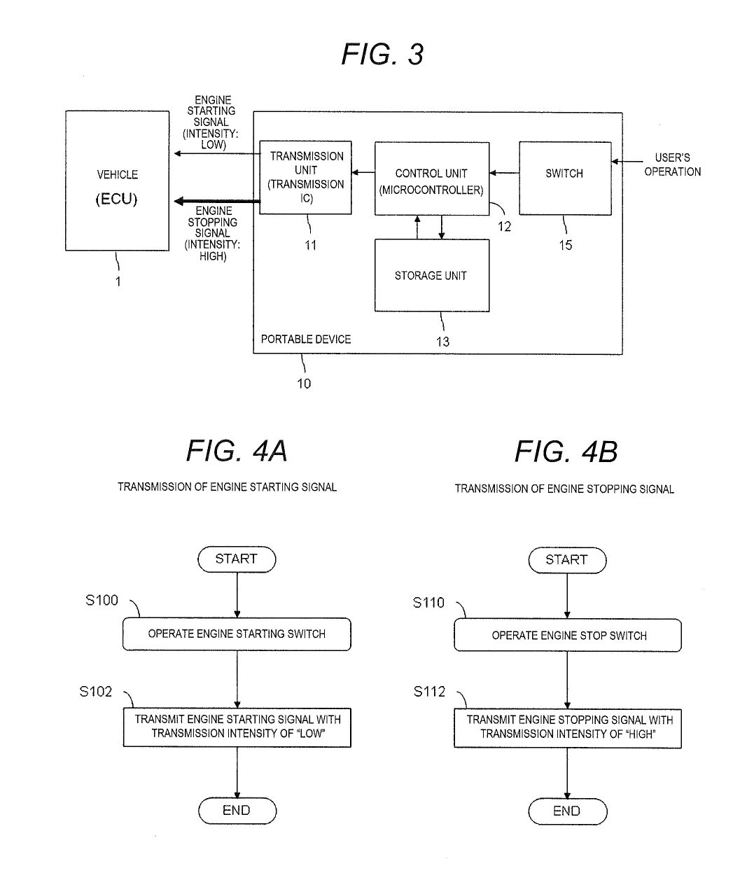

The portable device 10 will be described below with reference to FIG. 3. The portable device 10 includes a transmission unit 11 that transmits a signal to the vehicle 1, a control unit 12 that controls the communication using the transmission unit 11, a storage unit 13 that stores the transmission intensity of the signal transmitted from the transmission unit 11, and a switch 15 that receives a user's operation. Here, more specifically, the vehicle 1 is an onboard electronic control unit (ECU) having an antenna capable of receiving a signal from the portable device 10.

The transmission unit 11 is configured to transmit an engine starting signal for starting the engine of the vehicle 1 and an engine stopping signal for stopping the engine. The transmission unit 11 may be configured to transmit other signals for locking and unlocking the door of the vehicle 1. The engine starting signal and the engine stopping signal transmitted from the transmission unit 11 serve to start the engine of the vehicle 1 into the operation state and to stop the engine of the vehicle 1 in operation, respectively, when the signals are remotely received by the ECU of the vehicle 1.

The signal transmitted from the portable device 10 is normally sent out using radio waves of a ultra high frequency (UHF) band, but is not limited to the frequency band. The radio waves transmitted from the portable device 10 carry data using a method (frequency shift keying (FSK)) of changing carriers to low frequencies when the frequency is at the Lo level about a certain frequency f and changing carriers to high frequencies when the frequency is at the Hi level about the frequency f as illustrated in FIG. 6, but the invention is not particularly limited to this method. In the drawing, the curve in which the maximum transmission output intensity is P1 represents the relationship between the frequency and the transmission output intensity when the engine starting signal is transmitted, and the curve in which the maximum transmission output intensity is P2 represents the relationship between the frequency and the transmission output intensity when the engine stopping signal is transmitted.

The transmission unit 11 is constituted by a transmission integrated circuit (IC) and transmits the engine stopping signal for stopping the engine with a higher intensity than that of the engine starting signal for starting the engine of the vehicle 1 as described above. More specifically, as illustrated in FIG. 6, the transmission unit 11 outputs the small transmission output intensity P1 at the time of transmitting the engine starting signal, and outputs the large transmission output intensity P2 at the time of transmitting the engine stopping signal. The transmission output intensities are transmitted at appropriate SN ratios depending on noise environments thereof as described above.

According to this configuration, it is possible to guarantee the reliability of communication regardless of the state of the vehicle 1 generating noise and to prevent the operation state of the engine from being maintained, for example, even when the user performs the engine turning-off operation. Since it is not always necessary to transmit a signal with a high intensity, it is possible to suppress the power consumption of the portable device 10. By setting the transmission intensities transmitted by the transmission unit 11 to two levels, it is possible to transmit signals with the transmission intensities corresponding to two types of signals. When three types of signals are transmitted, three levels of transmission intensities may be provided and signals may be transmitted with the transmission intensities corresponding thereto. In the embodiment of the invention, since the transmission intensities are distinguished depending on the signal types of the engine starting signal and the engine stopping signal, the engine stopping signal is transmitted with a high transmission intensity even when the engine of the vehicle is actually stopped.

The storage unit 13 stores the transmission intensities of the engine starting signal and the engine stopping signal transmitted from the transmission unit 11. The storage unit 13 is generally constituted by a nonvolatile memory such as a read only memory (ROM) in order not to lose data even when the battery is completely discharged, but the invention is not particularly limited to this configuration. The switch 15 is a switch such as a push button and is not particularly limited in the type or the number thereof as long as it can receive a user's operation. For example, the switch may be a single button which is commonly used for plural functions, may include two push buttons as illustrated in FIGS. 1A and 1B, or may include two or more push buttons.

The control unit 12 is constituted by a microcontroller which controls the communication using the transmission unit 11 and controls the transmission process of the transmission unit 11 on the basis of reading and writing of data from and to the storage unit 13 and an input from a user using the switch 15. The control unit 12 may control the transmission unit 11 so as to transmit the engine starting signal and the engine stopping signal with the transmission intensities stored in advance in the storage unit 13. According to this configuration, it is possible to transmit signals with the transmission intensities appropriately set in advance depending on use environments or use situations of the vehicle 1 and the user.

The control unit 12 may control the transmission unit 11 so as to transmit the engine starting signal and the engine stopping signal when the user's operation of the switch 15 is detected. According to this configuration, it is possible to transmit both signals depending on the user's intention. FIGS. 4A and 4B are diagrams illustrating control flows in the control unit 12 when a dedicated switch for engine start and a dedicated switch for engine stop are separately disposed. As illustrated in the flowchart of FIG. 4A, when the portable device 10 transmits the engine starting signal, the control unit 12 detects, for example, an operation which is performed on the switch for engine start by the user in S100, and controls the transmission unit 11 so as to transmit the engine starting signal with a low transmission intensity in S102. S in the flowchart means a step.

On the other hand, as illustrated in FIG. 4B, when the portable device 10 transmits the engine stopping signal, the control unit 12 detects, for example, an operation on the switch for engine stop which is performed by the user in S110, and controls the transmission unit 11 so as to transmit the engine stopping signal with a high transmission intensity in S112. In this way, since two switches of the switch for transmitting the engine starting signal and the switch for transmitting the engine stopping signal are disposed, the user can easily perform the engine starting operation and the engine stopping operation.

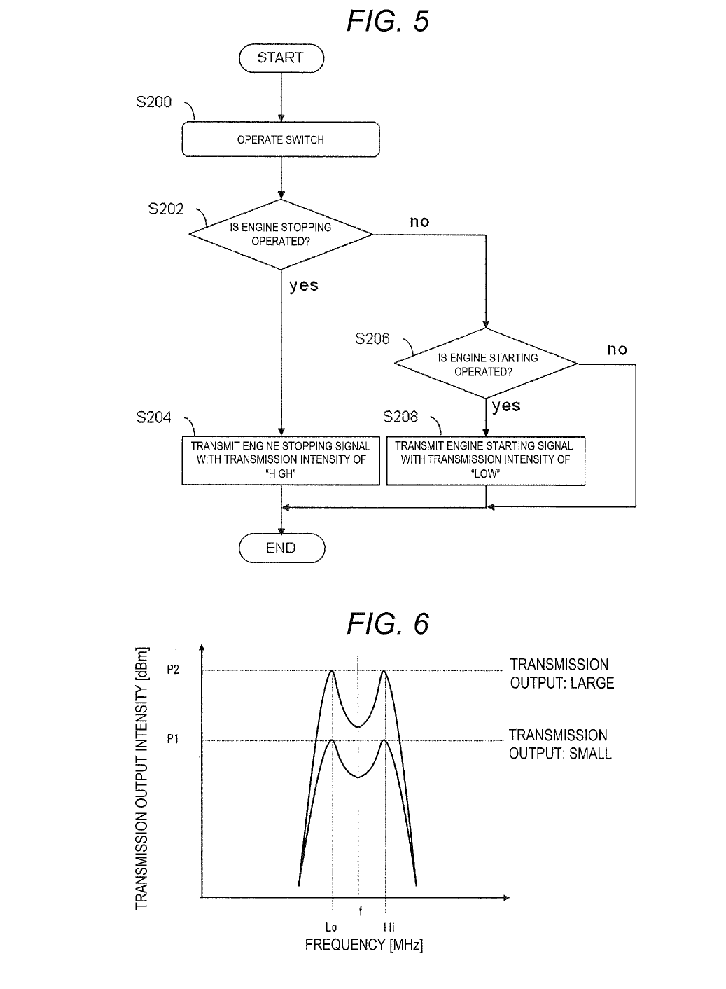

FIG. 5 is a diagram illustrating a control flow in the control unit 12 when a single switch is commonly used as the switch for engine start and the switch for engine stop (for example, a long pushing operation of the switch represents the engine start and a short pushing operation of the switch represents the engine stop) or when the engine starting signal or the engine stopping signal is transmitted by a combination of plural switches. The control unit 12 detects an operation on the switch 15 which is performed by the user in S200. The control unit 12 checks whether the detected operation is an engine stopping operation in S202. When the detected operation is an engine stopping operation, the control unit 12 transmits the engine stopping signal with a high transmission intensity in S204.

On the other hand, when the detected operation is not an engine stopping operation, the control unit 12 checks whether the detected operation is an engine starting operation in S206. When the detected operation is an engine starting operation, the control unit 12 transmits the engine starting signal with a low transmission intensity in S208. The control unit 12 may end the control flow without performing any particular process when the detected operation is not an engine starting operation, or may transmit a command signal based on the corresponding operation when the detected operation is another operation (not illustrated).

By performing this process, in a system having a remote engine start function, even when a user performs an engine turning-on operation and an engine turning-off operation from the same position, it is possible to avoid a situation in which the turning-on operation is possible but the turning-off operation is not possible. Generally, a user thinks that the turning-off operation can be performed at a position at which the turning-on operation can be performed. Accordingly, particularly, when the user operates the portable device at a remote position at which the user cannot see the vehicle with eyes or cannot hear engine sound of the vehicle, it is possible to avoid a situation in which the user tries to turn off the engine but the operation state of the engine is maintained, which cannot be recognized by the user.

Since the portable device 10 can guarantee the reliability of communication regardless of the state of the vehicle 1 generating noise and does not need to always transmit signals with a high transmission intensity, it is possible to suppress the power consumption of the portable device.

### MODIFICATION OF EMBODIMENT

The aforementioned embodiment of the invention is applied to a vehicle equipped with an engine, but the invention is not limited to the embodiment. The invention can be applied to, for example, an electric automobile not equipped with an engine, because noise varies depending on operation of an air conditioner, a car navigation device, a wiper, and the like.

When a user operates an electric automobile start switch of a portable device to transmit an electric automobile start signal in order to power on the electric automobile to start the electric automobile, the portable device transmits the electric automobile start signal in an environment in which there is no noise and thus can transmit the electric automobile start signal with a relatively-low transmission intensity. On the other hand, when the user operates an electric automobile stop switch to transmit an electric automobile stop signal in order to power off the electric automobile to stop the electric automobile, the portable device transmits in an environment in which there is noise and thus can transmit the electric automobile stop signal with a relatively-high transmission intensity. That is, the portable device corresponding to the electric automobile includes a transmission unit that transmits a start signal for starting the electric automobile and a stop signal for stopping the electric automobile and the transmission unit transmits the stop signal with an intensity higher than that when transmitting the start signal.

As a result, a signal transmitted from the portable device can be received by the electric automobile side in spite of the influence of noise generated from the electric automobile and it is thus possible to guarantee the reliability of communication without depending on the state of the electric automobile. For example, it is possible to prevent a situation in which a user tries to power off the electric automobile or the like but the powered-on state of the electric automobile or the like is maintained. Since it is not necessary to always transmit a signal with a high transmission intensity, it is possible to suppress the power consumption of the portable device.

The invention is not limited to the aforementioned embodiment, but can be put into practice by a configuration not departing from the gist of the appended claims. That is, while a specific embodiment of the invention has been particularly illustrated and described, those skilled in the art can add various modifications in the numbers and other detailed configurations to the aforementioned embodiment without departing from the technical ideas and objects of the invention.

1. A portable device comprising:
a transmission unit which transmits an engine starting signal for starting an engine of a vehicle and an engine stopping signal for stopping the engine of the vehicle to the vehicle,
wherein the transmission unit transmits the engine stopping signal with an intensity higher than that of the engine starting signal.

2. The portable device according to claim 1, further comprising:
a control unit which controls communication using the transmission unit; and
a storage unit which stores transmission intensities of the engine starting signal and the engine stopping signal,
wherein the control unit controls the transmission unit so as to transmit the engine starting signal and the engine stopping signal with the respective transmission intensities stored in the storage unit.

3. The portable device according to claim 2, further comprising:
at least one switch,
wherein the control unit controls the transmission unit so as to transmit the engine starting signal and the engine stopping signal in response to detection of an operation of the at least one switch.

4. The portable device according to claim 3,
wherein the at least one switch comprises:
an engine start switch for transmitting the engine starting signal; and
an engine stop switch for transmitting the engine stopping signal.

5. The portable device according to claim 1,
wherein the transmission intensities of the transmission unit have two levels.

6. A portable device comprising:
a transmission unit which transmits a starting signal for starting a vehicle and a stopping signal for stopping the vehicle to the vehicle,
wherein the transmission unit transmits the stopping signal with an intensity higher than that of the starting signal.
